(19) United States
(12) Patent Application Publication
(10) Pub. No.: US 2013/0009341 A1
(43) Pub. Date: Jan. 10, 2013

(54) METHOD FOR PROTECTING HOLE AND PROCESSING METHOD FOR OBJECT WITH HOLE

(75) Inventor: PENG-JUN JIANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., New Taipei (TW)

(21) Appl. No.: 13/217,268

(22) Filed: Aug. 25, 2011

(30) Foreign Application Priority Data
Jul. 8, 2011 (CN) 201110191090.3

(51) Int. Cl. B29C 45/40

(52) U.S. Cl. 264/267

(57) ABSTRACT

A method for protecting a hole includes putting an end of a handle in the hole, then filling the hole with material. The material is then cured to form a plug which protects the hole and can be pulled out to open the hole by the handle when needed.

### BACKGROUND

1. Technical Field

The present disclosure relates to a method for protecting a small hole, and a method for processing an object with a small hole.

2. Description of Related Art

Many workpieces, such as, housings of an electronic device, often define a number of small holes therein. When such a workpiece is anodized, printed, or plated, the small hole may be filled with unwanted stuffs or damaged.

### BRIEF DESCRIPTION OF THE DRAWINGS

Many aspects of the present embodiments can be better understood with reference to the following drawing. The components in the drawing are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a flowchart of an embodiment of a method for protecting a small hole.

FIG. 2 is a schematic view showing a process of the method of FIG. 1.

FIG. 3 is a flowchart of an embodiment of a processing method for an object with a small hole.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

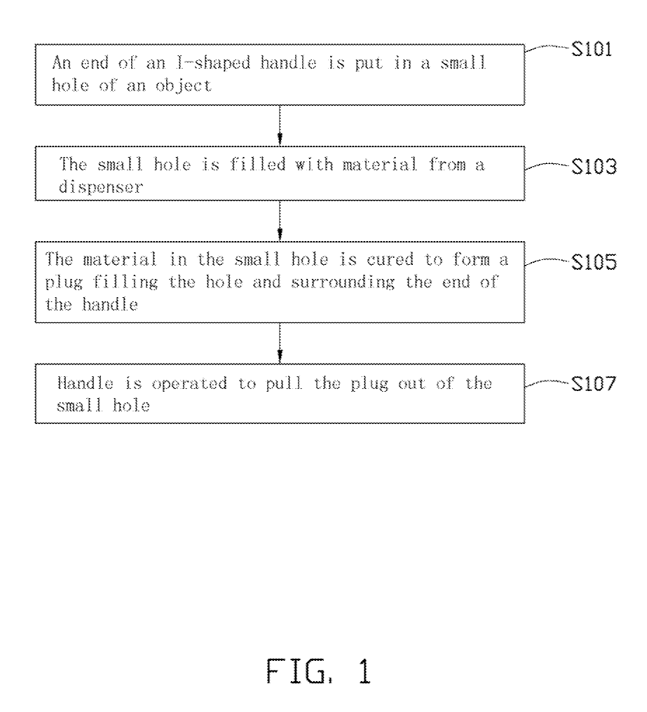

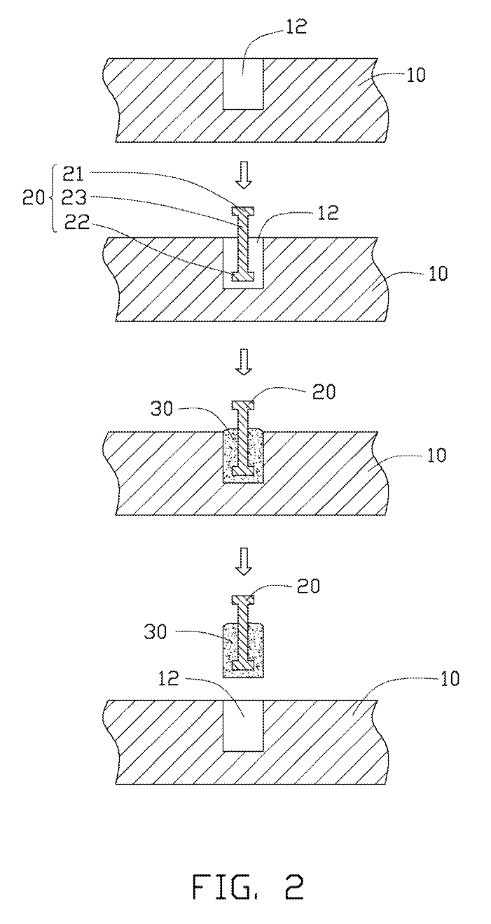

Referring to FIG. 1 and FIG. 2, an embodiment of a method for protecting a hole is provided to protect a small hole 12 in an object 10, when the object 10 is anodized, printed on, or plated. The method includes the following steps.

Step S101, an end of an I-shaped handle 20 is put in the small hole 12 of the object 10. The handle 20 includes a pole 23, an operation portion 21 and a hooking portion 22 that is the end put in the hole 12. The operation portion 21 is located outside the small hole 12.

Step S103, the small hole 12 is filled with material from a dispenser. The material is liquid and easy to be cured, such as adhesive.

Step S105, the material in the small hole 12 is cured to form a plug 30 filling the hole 12 and surrounding the hooking portion 21. Then the object 10 can be processed, such as anodized, printed, or plated, without damaging or filling the hole 12.

Step S107, the operation portion 21 is operated to pull the plug 30 out of the small hole 12 after the processing procedure is completed.

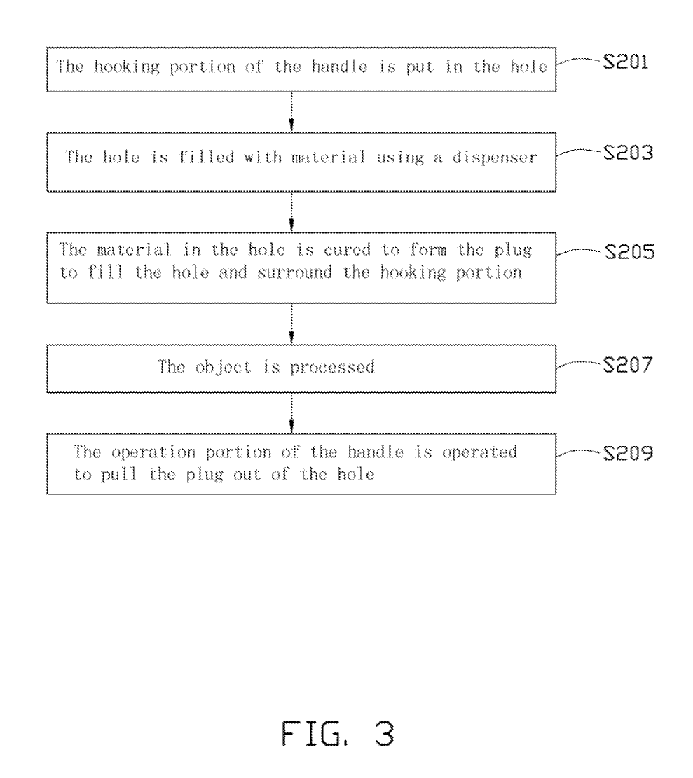

Referring to FIG. 3, a processing method for an object with a hole is provided and includes the following steps.

Step S201, the hooking portion 22 is put in the hole 12. The operation portion 21 is located outside the small hole 12.

Step S203, the hole 12 is filled with material using a dispenser.

Step S205, the material in the hole 12 is cured to form the plug 30 to fill the hole and surround the hooking portion 22.

Step S207, the object 10 is processed, such as anodized, printed, or plated, without anodizing, printing, or plating the sidewall bounding the hole 12.

Step S209, the operation portion 12 is operated to pull the plug 30 out of the hole 12.

The method for protecting a hole and the processing method allows for convenient protection of holes in the object 10 during anodizing, printing on, or plating without interfering with the processing or adding greatly to the expense and labor involved.

Even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A method for protecting a hole of an object, the method comprising:
putting an end of a handle in the hole of the object;
filling the hole by injecting material into the hole;
curing the material in the hole to form a plug filling the hole and surrounding the end of the handle; and
pulling the plug out of the hole.

2. The method of claim 1, wherein the handle is substantially I-shaped, and comprises a pole, an operation portion and a hooking portion that is the end put in the hole.

3. The method of claim 2, wherein the operation portion is located outside the hole.

4. The method of claim 1, wherein the material is adhesive.

5. A processing method for an object with a hole, the method comprising:
putting an end of a handle in the hole of the object;
filling the hole by injecting material into the hole;
curing the material in the hole to form a plug filling the hole and surrounding the end of the handle;
processing the object; and
pulling the plug out of the hole.

6. The processing method of claim 5, wherein during the step of processing the object, the object is be anodized, printed, or plated.

7. The processing method of claim 5, wherein handle is substantially I-shaped, and comprises a pole, an operation portion and a hooking portion that is the end put in the hole.

8. The processing method of claim 7, wherein the operation portion is located outside the hole.

9. The processing method of claim 5, wherein the material is adhesive.
